(19) United States
(12) Patent Application Publication
(10) Pub. No.: US 2024/0281788 A1
(43) Pub. Date: Aug. 22, 2024

(54) POINT-OF-SALE TERMINAL, METHOD, AND POINT-OF-SALE SYSTEM

(71) Applicant: Toshiba Tec Kabushiki Kaisha, Tokyo (JP)

(72) Inventor: Hidenori FUJIMAKI, Osaka Osaka (JP)

(21) Appl. No.: 18/423,126

(22) Filed: Jan. 25, 2024

(30) Foreign Application Priority Data
Feb. 22, 2023 (JP) 2023-026521

(51) Int. Cl. G06Q 20/20; G06Q 20/40

(52) U.S. Cl. CPC G06Q 20/204; G06Q 20/407

(57) ABSTRACT

A point-of-sale terminal includes a plurality of card readers each configured to read information from a credit card using a different reading method, and a processor configured to, upon selection of a reading method from a plurality of reading methods, perform a credit card settlement using one of the plurality of card readers corresponding to the selected reading method. The processor is configured to: search for a past credit card settlement, acquire data of the past credit card settlement, identify one of the plurality of reading methods that has been used for the past credit card settlement based on the data, control one of the plurality of card readers corresponding to the identified reading method to read a credit card, and upon receipt of information from the credit card via said one of the plurality of card readers, perform refund processing on the past credit card settlement using the information.

### CROSS-REFERENCE TO RELATED APPLICATION

This application is based upon and claims the benefit of priority from Japanese Patent Application No. 2023-026521, filed on Feb. 22, 2023, the entire contents of which are incorporated herein by reference.

### FIELD

Embodiments described herein relate generally to a point-of-sale (POS) terminal, a method performed thereby, and a POS system.

### BACKGROUND

To cancel a sales transaction for which payment has been completed with a credit card, that credit card needs to be presented for executing refund processing. In such a case, the credit card needs to be read by a credit card reader in such a way that the credit card was read to complete the sales transaction (e.g., wirelessly or magnetically). That is, in the refund processing, a salesclerk needs to check the reading method used for the payment and then operate the reader to read the credit card by the same reading method. This increases the workload of the salesclerk.

In view of such circumstances, there is a need for a technique that can reduce time and effort necessary to cancel a sales transaction in which a credit card was used and execute refund processing.

### BRIEF DESCRIPTION OF THE DRAWINGS

FIG. 1 is a block diagram showing a schematic configuration of a POS system including a POS terminal device and a POS server according to an embodiment.

FIG. 2 is a flowchart of transaction processing.

FIG. 3 is a flowchart of the transaction processing.

FIG. 4 shows an example of a first guide screen.

FIG. 5 shows an example of a window displayed on a salesclerk-side touch panel of the POS terminal device.

FIG. 6 shows an example of a screen displayed on a customer-side touch panel of the POS terminal device.

FIG. 7 shows an example of a window WIC displayed on the salesclerk-side touch panel of the POS terminal device.

FIG. 8 shows an example of a screen displayed on the customer-side touch panel of the POS terminal device.

FIG. 9 is a flowchart of past transaction processing.

FIG. 10 is a flowchart of the past transaction processing.

FIG. 11 shows an example of a second guide screen.

### DETAILED DESCRIPTION

Embodiments described herein provide a settlement device, a transaction processing device, and an information processing method that can reduce the time and effort of an operator in refund processing to cancel a credit card settlement.

In general, according to one embodiment, a POS terminal includes a plurality of card readers each configured to read information from a credit card using a different reading method, and a processor configured to, upon selection of a reading method from a plurality of reading methods, perform a credit card settlement using one of the plurality of card readers corresponding to the selected reading method. The processor is configured to: search for a past credit card settlement, acquire data of the past credit card settlement, identify one of the plurality of reading methods that has been used for the past credit card settlement based on the data, control one of the plurality of card readers corresponding to the identified reading method to read a credit card, and upon receipt of information from the credit card via said one of the plurality of card readers, perform refund processing on the past credit card settlement using the information.

Embodiments of this disclosure will now be described, using the drawings.

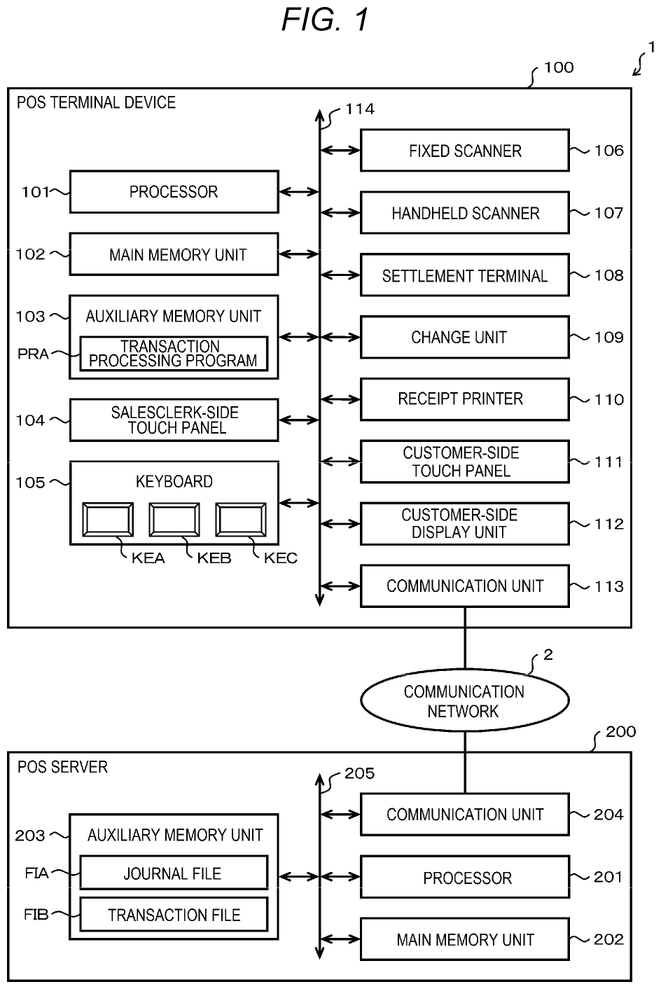

FIG. 1 is a block diagram showing a schematic configuration of a POS system 1 including a POS terminal device 100 and a POS server 200 according to an embodiment.

The POS system 1 includes the POS terminal device 100 and the POS server 200 configured to be able to communicate with each other via a communication network 2. As the communication network 2, a LAN (local area network) is typically used. However, as the communication network 2, one or a suitable combination of the internet, a VPN (virtual private network), a public communication network, a mobile communication network, and the like can be used other than a LAN.

The POS terminal device 100 performs processing for sales of merchandise items for a customer of a store. That is, the POS terminal device 100 is a transaction processing device that performs processing in connection with a transaction for merchandise sales. The POS terminal device 100 is also configured to execute a settlement as will be described later, as a part of the processing for a transaction, and also has a function as a settlement device.

The POS terminal device 100 is operated mainly by a salesclerk. The POS terminal device 100 is installed in a store or the like in the state of facing a work space for the salesclerk. A customer normally waits in a waiting space separately from the work space.

The POS terminal device 100 includes a processor 101, a main memory unit 102, an auxiliary memory unit 103, a salesclerk-side touch panel 104, a keyboard 105, a fixed scanner 106, a handheld scanner 107, a settlement terminal 108, a change unit 109, a receipt printer 110, a customer-side touch panel 111, a customer-side display unit 112, a communication unit 113, and a transmission path 114. The processor 101, the main memory unit 102, the auxiliary memory unit 103, the salesclerk-side touch panel 104, the keyboard 105, the fixed scanner 106, the handheld scanner 107, the settlement terminal 108, the change unit 109, the receipt printer 110, the customer-side touch panel 111, the customer-side display unit 112, and the communication unit 113 are connected to the transmission path 114. A part or all of the salesclerk-side touch panel 104, the keyboard 105, the fixed scanner 106, the handheld scanner 107, the settlement terminal 108, the change unit 109, the receipt printer 110, the customer-side touch panel 111, and the customer-side display unit 112 may be provided as a separate unit from a main unit including the processor 101, the main memory unit 102, the auxiliary memory unit 103, the communication unit 113, and the transmission path 114, and may be externally attached to the main unit.

The processor 101, the main memory unit 102, and the auxiliary memory unit 103 are coupled together via the transmission path 114 and together form a controller to execute information processing in connection with the control of the POS terminal device 100.

The processor 101 is a core component of the controller. The processor 101 executes information processing based on an information processing program such as an operating system, middleware, and/or an application program stored in the main memory unit 102 and the auxiliary memory unit 103, and thus controls each part of the POS terminal device 100 in order to perform various functions of the POS terminal device 100.

The main memory unit 102 includes a read-only memory area and a rewritable memory area. The read-only memory area of the main memory unit 102 stores a part of the foregoing information processing program. In some cases, the read-only memory area or the rewritable memory area of the main memory unit 102 may store necessary data for the processor 101 to execute processing to control each part. In the main memory unit 102, the rewritable memory area is used as a work area of the processor 101.

The auxiliary memory unit 103 has a known memory device such as an EEPROM (trademark registered) (electrically erasable programmable read-only memory), an HDD (hard disk drive), or an SSD (solid-state drive). The auxiliary memory unit 103 saves data used by the processor 101 to execute various processing and data generated as a result of processing by the processor 101. In some cases, the auxiliary memory unit 103 may store the foregoing information processing program. In an embodiment, the auxiliary memory unit 103 stores a transaction processing program PRA. The transaction processing program PRA is an application program for executing information processing, described later, to process a sales transaction.

The salesclerk-side touch panel 104 is provided on the salesclerk side. The salesclerk-side touch panel 104 displays a screen to show information for the salesclerk. The salesclerk-side touch panel 104 also accepts an input of an instruction based on a touch operation to the screen by the salesclerk.

The keyboard 105 has a number of hardware keys in such a way that the salesclerk can easily operate those keys from the salesclerk side. The keyboard 105 accepts an input of an instruction by the salesclerk pressing those keys. The hardware keys provided on the keyboard 105 include keys KEA, KEB, KEC to accept the designation of a credit card reading method.

The fixed scanner 106 has a reading window facing the salesclerk side. The fixed scanner 106 captures an image of a merchandise item held in front of the reading window and then recognizes barcode information represented by a barcode formed on the merchandise item, by image processing. The fixed scanner 106 outputs the barcode information to the processor 101. The fixed scanner 106 can be a device of another type that optically reads a barcode, using the reflection of a laser beam. The fixed scanner 106 can also be a device of a type having a function of specifying a merchandise item, using an object recognition technique based on an image of the merchandise item itself acquired by image pickup of the merchandise item.

The handheld scanner 107 is used, held in a hand of the salesclerk, and optically reads a barcode placed opposite a reading port. The handheld scanner 107 outputs barcode information represented by the barcode thus read, to the processor 101.

The settlement terminal 108 is a reading device that reads data recorded on a card for settlement such as a credit card, a prepaid card, or an electronic money card. The settlement terminal 108 writes data onto the card for settlement. The settlement terminal 108 has a plurality of card readers corresponding to IC (integrated circuit) reading, magnetic reading, and near-field communication reading of a credit card. The reading device for IC reading reads data stored in an IC provided in a credit card, by communication via an electrical contact point. The reading device for magnetic reading reads data magnetically recorded on a magnetic stripe formed on a surface of a credit card, using a magnetic head. Therefore, both of the IC reading and the magnetic reading involve contact between the settlement terminal 108 and the credit card and are an example of contact reading. Both of the reading devices for IC reading and for magnetic reading are referred to as a contact reading device. The reading device for near-field communication reading reads data stored in an IC provided in a credit card, by wireless communication such as NFC (near-field communication). Therefore, the near-field communication reading is contactless reading. The reading device for near-field communication reading is referred to as a contactless reading device.

The change unit 109 counts the value of a coin inserted from a coin insertion port and stores the coin in an inner container. The change unit 109 discharges a coin stored in the container to a coin tray via a coin discharge port. The change unit 109 also counts the value of a bill inserted from a bill insertion port and stores the bill in the inner container. The change unit 109 discharges a bill stored in the container from a bill discharge port. The bill discharge port holds the discharged bill in the state of being partly exposed to outside.

The receipt printer 110 prints an image of a receipt, an acknowledgement or a sales slip on a receipt paper. The receipt printer 110 discharges the receipt paper with the foregoing image printed thereon, to outside from a receipt discharge port.

The customer-side touch panel 111 is provided on the customer side. The customer-side touch panel 111 displays a screen to show information to the customer. The customer-side touch panel 111 accepts an input of an instruction based on a touch operation to the screen by the customer.

The customer-side display unit 112 is provided on the customer side. The customer-side display unit 112 displays a screen to show information to the customer. The customer-side display unit 112 is adapted to mainly display character strings and displays a simpler screen than the customer-side touch panel 111.

The communication unit 113 executes communication processing for transmitting and receiving various data to and from any device such as the POS server 200 via the communication network 2. As the communication unit 113, a network interface circuit conforming to the communication system of the communication network 2 can be used.

The transmission path 114 includes an address bus, a data bus, and a control signal line or the like. The transmission path 114 transmits data and signals transmitted and received between the components connected to the transmission path 114.

As the basic hardware of the POS terminal device 100, for example, the hardware of an existing POS terminal device can be used. In this case, the POS terminal device 100 is generally provided in the state where the transaction processing program PRA is stored in the auxiliary memory unit 103. However, the hardware of the POS terminal device 100 in the state where the transaction processing program PRA is not stored in the auxiliary memory unit 103 and the transaction processing program PRA may be provided separately. Then, the transaction processing program PRA may be written into the auxiliary memory unit 103 in response to an operation by any worker.

Alternatively, the hardware of the POS terminal device 100 in the state where an information processing program of the same type as the transaction processing program PRA but a different version is stored in the auxiliary memory unit 103 and the transaction processing program PRA may be provided separately. Then, the transaction processing program PRA may be written in the form of overwriting the information processing program already stored in the auxiliary memory unit 103. The transaction processing program PRA can be provided in the form of being recorded in a removable recording medium such as a magnetic disk, a magneto-optical disk, an optical disk, or a semiconductor memory, or by communication via a network. The transaction processing program PRA may be stored in the main memory unit 102.

The POS server 200 has a processor 201, a main memory unit 202, an auxiliary memory unit 203, a communication unit 204, and a transmission path 205 or the like. The processor 201, the main memory unit 202, the auxiliary memory unit 203, and the communication unit 204 are configured to be able to communicate with each other via the transmission path 205.

The processor 201, the main memory unit 202, and the auxiliary memory unit 203 are connected to each other via the transmission path 205 and thus form a controller to execute information processing to control the POS server 200.

The processor 201 is a core component of the computer. The processor 201 executes information processing to control each part of the POS server 200 in order to perform various functions thereof, according to an information processing program such as an operating system and an application program.

The main memory unit 202 includes a read-only memory area and a rewritable memory area. The read-only memory area of the main memory unit 202 stores a part of the foregoing information processing program. In some cases, the read-only memory area or the rewritable memory area of the main memory unit 202 may store necessary data for the processor 201 to execute processing to control each part of the POS server 200. In the main memory unit 202, the rewritable memory area is used as a work area of the processor 201.

As the auxiliary memory unit 203, for example, an EEPROM, an HDD, an SSD, or various other known memory devices can be used. The auxiliary memory unit 203 stores data used by the processor 201 to execute various processing and data generated as a result of processing by the processor 201. In some cases, the auxiliary memory unit 203 may store the foregoing information processing program.

A part of the memory area of the auxiliary memory unit 203 is used as an area to store a journal file FIA and a transaction file FIB. The journal file FIA is a data file where journal data generated on a per transaction basis are gathered. The transaction file FIB is a data file where transaction data generated on a per transaction basis at the POS terminal device 100 are gathered.

The communication unit 204 executes communication processing to perform data communication via the communication network 2. As the communication unit 204, a network interface circuit conforming to the communication system of the communication network 2 can be used.

The transmission path 205 includes an address bus, a data bus, and a control signal line or the like, and transmits data and control signals transmitted and received between the components connected to the transmission path 205.

Operations of the POS system 1 will now be described. The content of the processing described below is mainly the description of processing related to characteristic operations. The description of processing executed in a conventional POS system may be omitted. For example, there is a case where, in response to a tap on a button to designate “Back” in a display on a screen, processing to return to the operation state preceding the display on the screen is executed. The description of such standard processing is omitted. The processing described below is an example for purposes of description. A change in the order of processes, an omission of processes in whole or in part, and the like, can be made according to need.

As the POS terminal device 100 is started up in an operation state for transaction processing, the processor 101 starts information processing based on the transaction processing program PRA (hereinafter referred to as transaction processing).

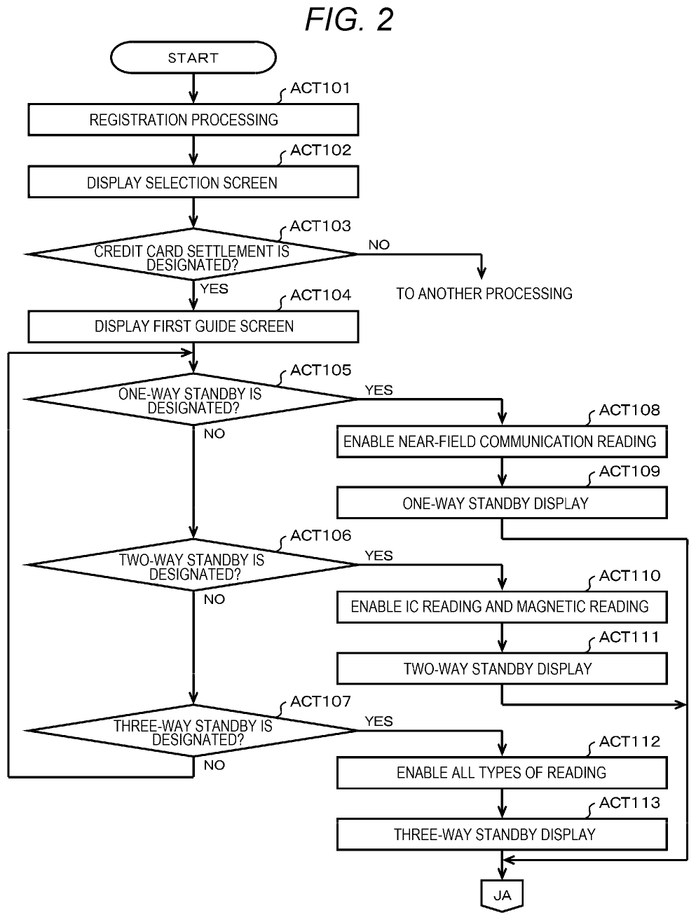

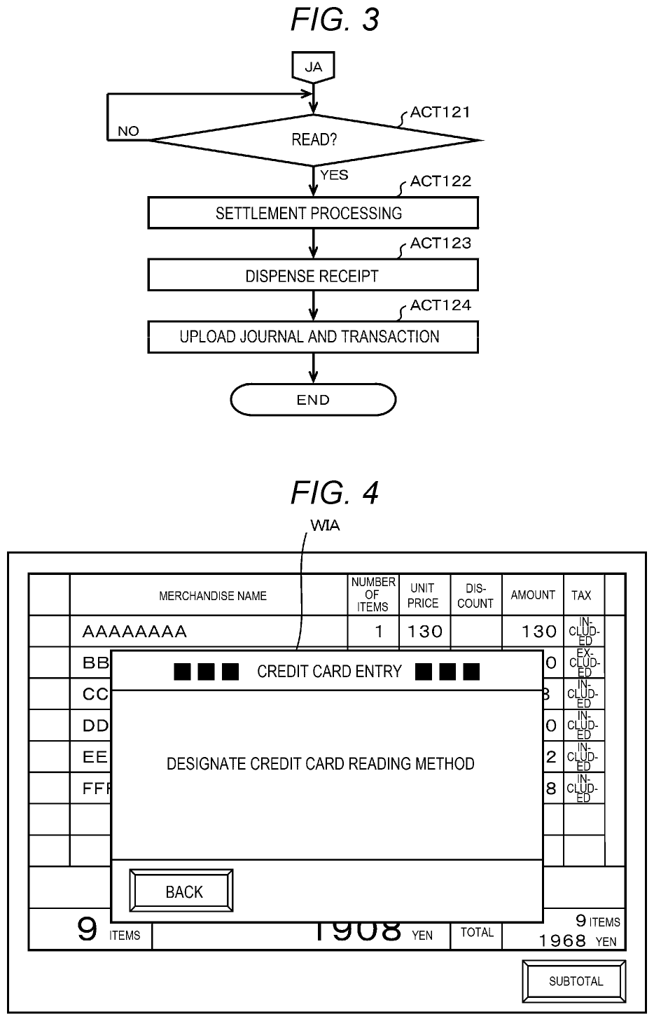

FIGS. 2 and 3 are flowcharts of the transaction processing. In ACT 101 in FIG. 2, the processor 101 executes registration processing. The registration processing is processing to register a merchandise item to be purchased by a customer as a target of a transaction (hereinafter referred to as a transaction merchandise item). The processor 101 generates and edits transaction data representing a list of transaction merchandise items, in response to a predetermined operation by an operator to give an addition instruction, a deletion instruction, or a number-of-items change instruction about transaction merchandise items. The operation carried out by the salesclerk to give an addition instruction is, for example, an operation to scan a barcode placed on a merchandise item, using the fixed scanner 106 or the handheld scanner 107. The operation carried out by the salesclerk to give an addition instruction is, for example, an operation on the salesclerk-side touch panel 104 or the keyboard 105 to directly enter a merchandise code. The operation carried out by the salesclerk to give an addition instruction is, for example, an operation on the salesclerk-side touch panel 104 or the keyboard 105 such as pressing a preset key of a merchandise item that indicates the merchandise item and is set in advance. That is, the processor 101 accepts an operation similar to an operation carried out at a conventional POS terminal device. When generating and editing the transaction data, the processor 101 executes, for example, processing similar to processing executed by a conventional POS terminal device. The processor 101 thus executes the information processing based on the transaction processing program PRA to function as a registration unit.

The processor 101 ends the registration processing in response to a predetermined operation to give an instruction to start payment, and then proceeds to ACT 102.

In ACT 102, the processor 101 causes the salesclerk-side touch panel 104 to display a selection screen that allows the operator to select a settlement or payment method. The processor 101 may cause the customer-side touch panel 111 to display the selection screen as well. The POS terminal device 100 can accept various known settlement methods such as cash settlement, credit card settlement, electronic money settlement, code settlement, prepaid card settlement, voucher settlement, and loyalty point settlement. The selection screen is predetermined to enable the selection of one of these acceptable settlement methods. What settlement method can be selected on the selection screen may be suitably defined, for example, by the manager of the POS terminal device 100.

In ACT 103, the processor 101 checks whether credit card settlement is designated. If not, the processor 101 checks which of the other settlement methods is designated, and proceeds to other processing such as executing the settlement by that other settlement method. This other processing may be similar to, for example, processing executed in a conventional POS terminal device.

As the operator selects credit card settlement, the processor 101 gives YES in ACT 103 and proceeds to ACT 104

In ACT 104, the processor 101 causes the salesclerk-side touch panel 104 to display a first guide screen. The first guide screen is a GUI (graphical user interface) to prompt the operator to designate one of one-way standby, two-way standby, and three-way standby in connection with the reading of the credit card, and to accept the designation. In this case, “one-way standby” is a standby state for near-field communication reading only. “Two-way standby” is a standby state for IC reading and magnetic reading. “Three-way standby” is a standby state for near-field communication reading, IC reading, and magnetic reading.

FIG. 4 shows an example of the first guide screen. In various screens shown in the drawings from FIG. 4 to FIG. 11, the illustration of a part of display objects may be omitted. The first guide screen is a screen showing a list of registered transaction merchandise items, with a window WIA displayed as a popup window.

The processor 101 proceeds to ACT 105 in the state where the first guide screen is displayed.

In ACT 105, the processor 101 checks whether one-way standby is designated. If not, the processor 101 gives NO and proceeds to ACT 106.

In ACT 106, the processor 101 checks whether two-way standby is designated. If not, the processor 101 gives NO and proceeds to ACT 107.

In ACT 107, the processor 101 checks whether three-way standby is designated. If not, the processor 101 gives NO and returns to ACT 105.

Thus, in ACTS 105 to 107, the processor 101 waits for the designation of one of one-way standby, two-way standby, and three-way standby.

If the customer wishes to use contactless settlement with a credit card, the salesclerk designates one-way standby by a predetermined operation such as pressing the key KEA provided on the keyboard 105. In response to this designation, the processor 101 gives YES in ACT 105 and proceeds to ACT 108.

In ACT 108, the processor 101 enables only near-field communication reading at the settlement terminal 108. Thus, the settlement terminal 108 is in the state of attempting to read data recorded on the credit card (hereinafter referred to as card data) by wireless communication such as NFC.

In ACT 109, the processor 101 shows a one-way standby display. The one-way standby display is a display to guide the salesclerk and the customer to hold a credit card that supports contactless settlement over the settlement terminal 108. The processor 101, for example, causes the salesclerk-side touch panel 104 and the customer-side touch panel 111 to display a predetermined screen for the one-way standby display. The processor 101 also causes the customer-side display unit 112 to display a text message such as “Tap your card”.

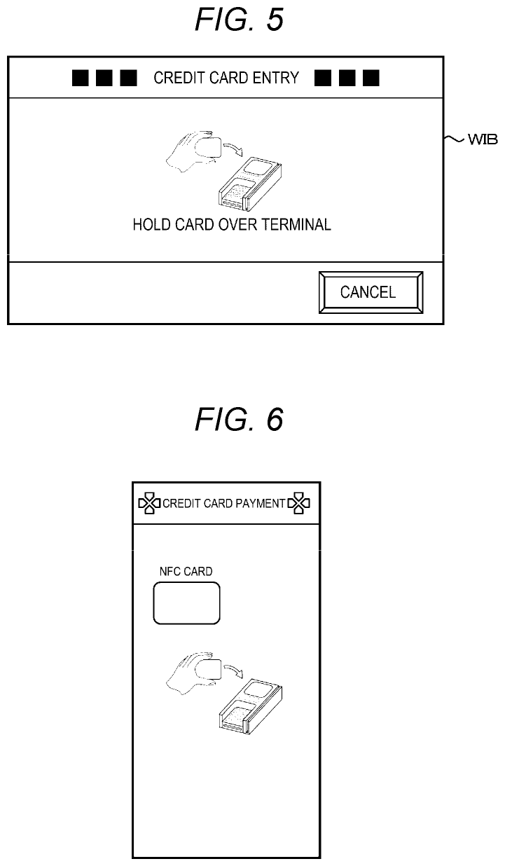

FIG. 5 shows an example of a window WIB displayed on the salesclerk-side touch panel 104 for the one-way standby display. The processor 101, for example, causes the window WIB to be displayed as a popup window instead of the window WIA on the screen displayed on the salesclerk-side touch panel 104.

FIG. 6 shows an example of a screen displayed on the customer-side touch panel 111 for the one-way standby display.

If the customer wants to use credit card settlement by IC reading or magnetic reading, the salesclerk designates two-way standby by a predetermined operation such as pressing the key KEB provided on the keyboard 105. In response to this designation, the processor 101 gives YES in ACT 106 and proceeds to ACT 110.

In ACT 110, the processor 101 enables IC reading and magnetic reading at the settlement terminal 108. Thus, the settlement terminal 108 is in the state of attempting to read card data from the credit card by IC reading and magnetic reading.

In ACT 111, the processor 101 shows a two-way standby display. The two-way standby display is a display to guide the salesclerk and the customer to insert an IC card-type credit card into the settlement terminal or scan a magnetic card-type credit card. The processor 101, for example, causes the salesclerk-side touch panel 104 and the customer-side touch panel 111 to display a predetermined screen for the two-way standby display. The processor 101 also causes the customer-side display unit 112 to display a text message such as “Insert or swipe your card”.

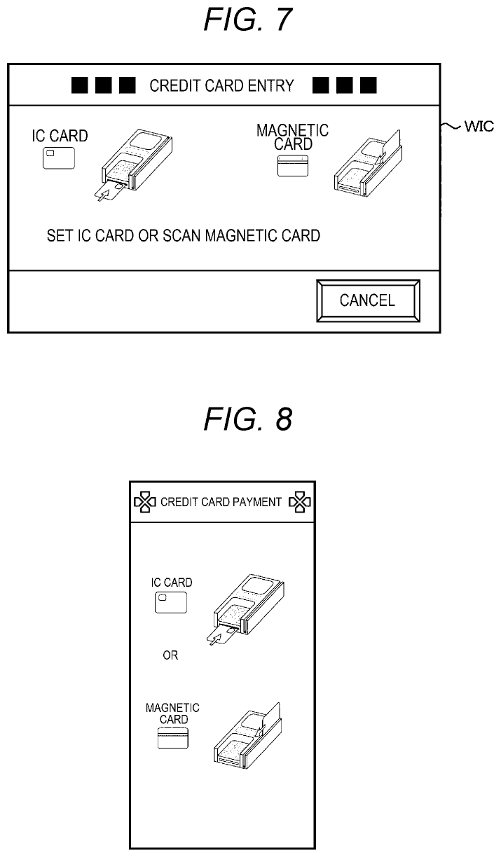

FIG. 7 shows an example of a window WIC displayed on the salesclerk-side touch panel 104 for the two-way standby display. The processor 101, for example, causes the window WIC to be displayed as a popup window instead of the window WIA on the screen displayed on the salesclerk-side touch panel 104.

FIG. 8 shows an example of a screen displayed on the customer-side touch panel 111 for the two-way standby display.

The salesclerk may designate three-way standby without checking the reading method desired by the customer. Alternatively, even if the salesclerk checks the reading method desired by the customer, the salesclerk may designate three-way standby. In this case, the salesclerk designates three-way standby by a predetermined operation such as pressing the key KEC provided on the keyboard 105. In response to this designation, the processor 101 gives YES in ACT 107 and proceeds to ACT 112.

In ACT 112, the processor 101 enables all of near-field communication reading, IC reading, and magnetic reading at the settlement terminal 108. Thus, the settlement terminal 108 is in the state of attempting to read card data from the credit card by near-field communication reading, IC reading, and magnetic reading.

In ACT 113, the processor 101 shows a three-way standby display. The three-way standby display is a display to guide the salesclerk and the customer to hold a credit card that supports contactless settlement over the settlement terminal, insert an IC card-type credit card into the settlement terminal, or scan a magnetic card-type credit card. The processor 101, for example, causes the salesclerk-side touch panel 104 and the customer-side touch panel 111 to display a predetermined screen for the three-way standby display. The processor 101 also causes the customer-side display unit 112 to display a text message such as “Tap, insert, or swipe your card”.

The window displayed as a popup window on the salesclerk-side touch panel 104 for the three-way standby display is a window showing both the illustration shown in the window WIB in FIG. 5 and the illustration shown in the window WIC in FIG. 7. Alternatively, the window WIB and the window WIC may be displayed alternately.

The screen displayed on the customer-side touch panel 111 for the three-way standby display is a screen showing both the illustration shown on the screen in FIG. 6 and the illustration shown on the screen in FIG. 8. Alternatively, the screen in FIG. 6 and the screen in FIG. 8 may be displayed alternately.

After finishing ACT 109, ACT 111 or ACT 113 in FIG. 2, the processor 101 proceeds to ACT 121 in FIG. 3. In ACT 121, the processor 101 waits for card data to be read at the settlement terminal 108.

If a credit card that supports contactless settlement is moved toward the settlement terminal 108 when near-field communication reading is enabled, the settlement terminal 108 performs wireless communication with a communication circuit provided on this credit card and reads out card data stored in a memory provided on this credit card. If an IC card-type credit card is inserted in an insertion slot when IC reading is enabled, and electrical contact with an IC provided on this credit card is performed, the settlement terminal 108 reads out card data stored in a memory included in the IC, via the electrical connection. If a credit card is scanned through a scan slit when magnetic reading is enabled, the settlement terminal 108 reads card data magnetically recorded on a magnetic stripe formed on this credit card. The settlement terminal 108 saves the card data thus read, into the main memory unit 102 or the auxiliary memory unit 103, and then notifies the processor 101 of the reading. On receiving the notification, the processor 101 gives YES in ACT 121 and proceeds to ACT 122.

In ACT 122, the processor 101 executes settlement processing. That is, the processor 101 executes known processing to calculate the amount of settlement for all the transaction merchandise items registered in ACT 101 in FIG. 2 and request a settlement server, not shown in FIG. 1, to perform a credit card settlement for the amount of settlement, with a notification of a credit card number included in the card data read from the credit card by the settlement terminal 108. The processor 101 thus executes the information processing based on the transaction processing program PRA to function as a settlement unit.

In ACT 123, the processor 101 controls the receipt printer 110 to dispense a receipt for the transaction of this time. That is, the processor 101 generates, for example, a receipt image showing the content of the transaction of this time and the result of payment, and causes the receipt printer 110 to print this receipt image.

In ACT 124, the processor 101 controls the communication unit 113 to upload the journal data and the transaction data about the transaction of this time to the POS server 200. The processor 101 then ends the transaction processing in connection with the one transaction.

The journal data is digital data representing information equivalent to the information shown in the transaction receipt. The information included in the journal data need not perfectly coincide with the information shown in the transaction receipt. The transaction data is digital data representing more detailed information than the journal data in connection with the processing of the transaction that is the processing target of this time. The transaction data is, for example, data representing information about each individual operation performed at the POS terminal device 100 in connection with the processing of the transaction that is the processing target of this time, in correlation with the operation. That is, a settled transaction can be managed, based on the journal data and the transaction data. Each of the journal data and the transaction data is management data to manage a settled transaction. What information is included in the journal data and the transaction data by the processor 101 may be suitably defined, for example, by the designer or the manager of the POS terminal device 100, or the like. However, the processor 101 includes, in the journal data, reading method data representing the method for reading the card data from the credit card. The processor 101 thus executes the information processing based on the transaction processing program PRA to function as an addition unit.

When the communication unit 204 has received the uploaded journal data and transaction data, the processor 201 of the POS server 200 updates the journal file FIA and the transaction file FIB to include this journal data and transaction data. Thus, information about the processed transaction in the POS system 1 is gathered in the journal file FIA and the transaction file FIB.

Incidentally, there is a case where, on the day of the settlement or later, the customer requests a salesclerk for the return of a transaction merchandise item related to a transaction for which the settlement of the price is finished by the processing as described above. In this case, the salesclerk designates transaction search by a predetermined operation on the salesclerk-side touch panel 104 or the keyboard 105.

At the POS terminal device 100, when transaction search is designated, the processor 101 executes past transaction processing based on the transaction processing program PRA. This past transaction processing and the foregoing transaction processing may be executed according to separate application programs from each other.

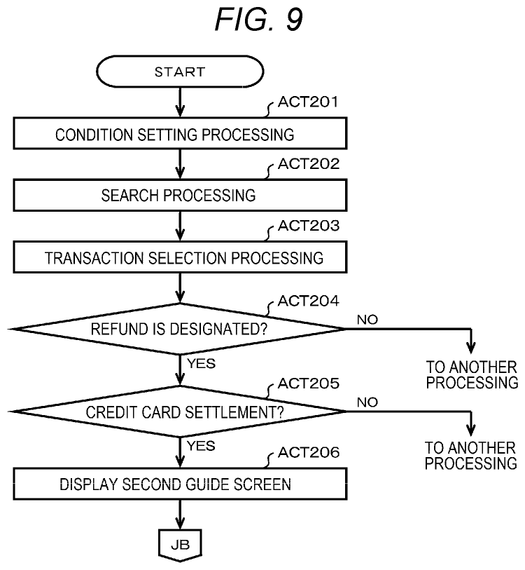

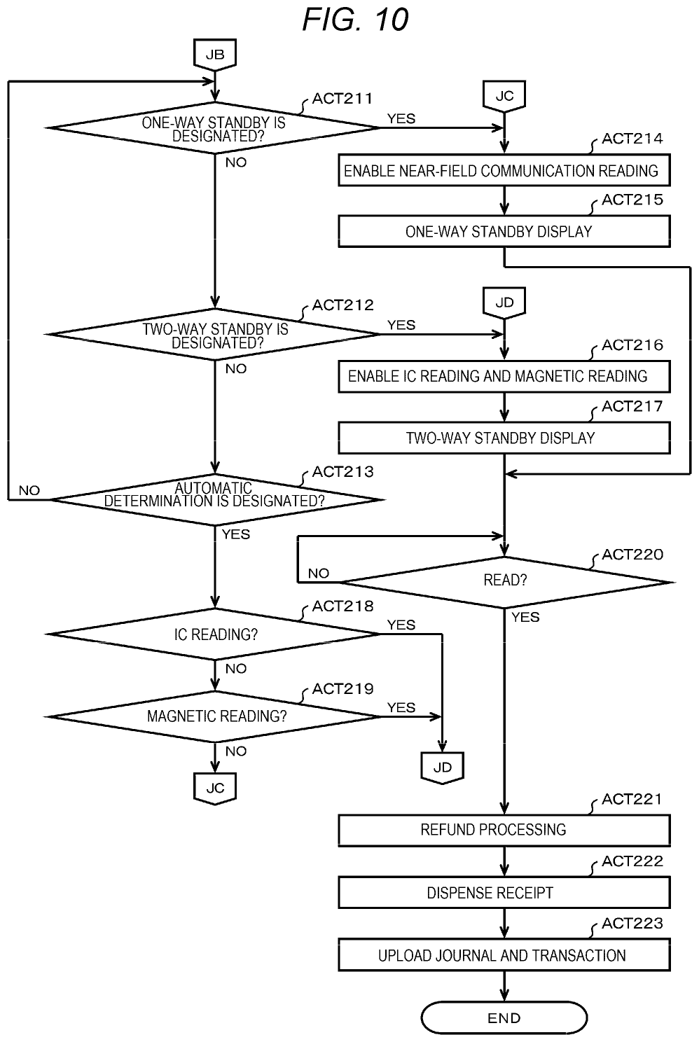

FIGS. 9 and 10 are flowcharts of the past transaction processing.

In ACT 201 in FIG. 9, the processor 101 executes condition setting processing. That is, the processor 101 sets a search condition desired by the salesclerk to search for a settled transaction, while accepting the operation from the salesclerk. The processor 101 sets, for example, a combination of at least one of information such as the checkout machine number, the date, the transaction number, and the amount of settlement shown in the transaction receipt, as the search condition.

In ACT 202, the processor 101 executes search processing. That is, the processor 101 requests, for example, the POS server 200 for transaction search, with a notification of the search condition set in ACT 201. At the POS server 200, in response to the request, the processor 201 searches for a transaction that matches the search condition and responds to the POS terminal device 100 with list data representing a list of the corresponding transactions. At the POS terminal device 100, the processor 101 acquires the list data.

In ACT 203, the processor 101 executes transaction selection processing. That is, the processor 101, for example, causes the salesclerk-side touch panel 104 to display a transaction list screen based on the list data acquired in ACT 201. The processor 101 then selects one transaction to be a processing target (hereinafter referred to as a target transaction) in response to an operation by the salesclerk. Also, the processor 101 acquires the journal data about the target transaction from the POS server 200. Then, the processor 101, for example, causes the salesclerk-side touch panel 104 to display a screen showing the content of the target transaction based on the acquired journal data.

In ACT 204, the processor 101 checks whether a refund for the target transaction is designated. If not, the processor 101 checks the content of the instruction by the operator and then shifts to execute an operation corresponding to the instruction. This other processing in this case may be similar to, for example, processing executed in a conventional POS terminal device.

If the salesclerk determines that a refund of the settled price for the target transaction should be made to the customer, the salesclerk designates a refund, for example, by a predetermined operation on the salesclerk-side touch panel 104 or the keyboard 105. In response to this designation, the processor 101 gives YES in ACT 204 and proceeds to ACT 205.

In ACT 205, the processor 101 checks whether the settlement of the price for the target transaction has been made by credit card settlement. If not, the processor 101 checks the settlement method and then shifts to processing for the refund corresponding to the settlement method. This other processing may be similar to, for example, processing executed by a conventional POS terminal device.

If the settlement of the price for the target transaction has been made by credit card settlement, the processor 101 gives YES in ACT 205 and proceeds to ACT 206.

In ACT 206, the processor 101 causes the salesclerk-side touch panel 104 to display a second guide screen. The second guide screen is a GUI screen to prompt the operator to designate one of one-way standby and two-standby in connection with the reading of the credit card, and to accept the designation.

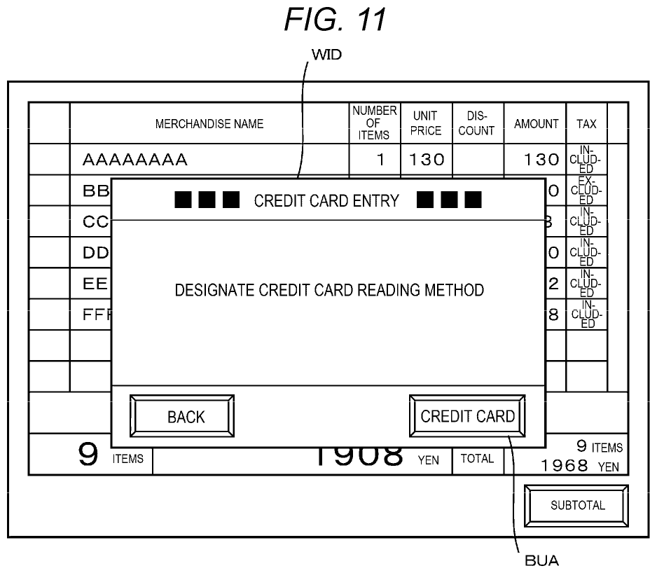

FIG. 11 shows an example of the second guide screen. The second guide screen is a screen showing the content of the target transaction with a window WID displayed as a popup window. The window WID shows a button BUA. The button BUA is a software key for the operator to designate automatic determination about which of one-way standby and two-way standby to shift to.

The processor 101 proceeds to ACT 211 in FIG. 10 in the state where the second guide screen is displayed. In ACT 211, the processor 101 checks whether one-way standby is designated. If not, the processor 101 gives NO and proceeds to ACT 212.

In ACT 212, the processor 101 checks whether two-way standby is designated. If not, the processor 101 gives NO and proceeds to ACT 213.

In ACT 213, the processor 101 checks whether automatic determination is designated. If not, the processor 101 gives NO and returns to ACT 211. Thus, in ACTS 211 to 213, the processor 101 waits for the designation of one of one-way standby, two-way standby, and automatic determination.

If it is confirmed that a contactless settlement with a credit card has been made in connection with the target transaction, the salesclerk designates one-way standby by a predetermined operation such as pressing the key KEA provided on the keyboard 105. In response to this designation, the processor 101 gives YES in ACT 211 and proceeds to ACT 214.

In ACT 214, the processor 101 enables only near-field communication reading at the settlement terminal 108. Thus, the settlement terminal 108 is in the state of attempting to read card data from the credit card by wireless communication such as NFC.

In ACT 215, the processor 101 shows a one-way standby display, as in ACT 109 in FIG. 9.

If it is confirmed that a credit card settlement by IC reading or magnetic reading has been made in connection with the target transaction, the salesclerk designates two-way standby by a predetermined operation such as pressing the key KEB provided on the keyboard 105. In response to this designation, the processor 101 gives YES in ACT 212 and proceeds to ACT 216.

In ACT 216, the processor 101 enables IC reading and magnetic reading at the settlement terminal 108. Thus, the settlement terminal 108 is in the state of attempting to read card data from the credit card by IC reading and magnetic reading.

In ACT 217, the processor 101 shows a two-way standby display, as in ACT 111 in FIG. 9.

The salesclerk can designate automatic determination by a predetermined operation such as tapping on the button BUA, without checking which reading method is applied in connection with the target transaction, or even when checking which reading method is applied. In response to this designation, the processor 101 gives YES in ACT 213 and proceeds to ACT 218.

In ACT 218, the processor 101 checks whether a credit card settlement by IC reading has been made in connection with the target transaction or not, based on the reading method data included in the journal data acquired in ACT 203. If a credit card settlement by IC reading has not been made, the processor 101 gives NO and proceeds to ACT 219.

In ACT 219, the processor 101 checks whether a credit card settlement by magnetic reading has been made in connection with the target transaction, based on the reading method data included in the journal data acquired in ACT 203. If a credit card settlement by magnetic reading has not been made, the processor 101 gives NO, proceeds to ACT 214, and executes the processing from ACT 214 onward, similarly to the above. That is, if the reading method data included in the journal data acquired in ACT 203 does not represent “IC reading” or “magnetic reading”, that is, if this reading method data represents “near-field communication reading”, the processor 101 assumes that one-way standby is designated, and executes ACT 214 and ACT 215.

If a credit card settlement by IC reading has been made in connection with the target transaction, the processor 101 gives YES in ACT 218. If a credit card settlement by magnetic reading has been made in connection with the target transaction, the processor 101 gives YES in ACT 219. In both cases, the processor 101 proceeds to ACT 216 and executes the processing from ACT 216 onward, similarly to the above. That is, if the reading method data included in the journal data acquired in ACT 203 represents “IC reading” or “magnetic reading”, the processor 101 assumes that two-way standby is designated, and executes ACT 216 and ACT 217.

As described above, in ACT 218 and ACT 219, the processor 101 determines which of contact reading and contactless reading is used in connection with the credit card settlement for the target transaction, and forms the state of executing contact reading or the state of executing contactless reading, based on the result of the determination. The processor 101 thus executes the information processing based on the transaction processing program PRA to function as a determination unit and a reading control unit.

After finishing ACT 215 or ACT 217, the processor 101 proceeds to ACT 220.

In ACT 220, the processor 101 waits for the card data recorded on the credit card to be read at the settlement terminal 108, as in ACT 121 in FIG. 3. On receiving a notification of the reading as described above from the settlement terminal 108, the processor 101 gives YES and proceeds to ACT 221.

In ACT 221, the processor 101 executes refund processing to make a refund for the settled price in connection with the target transaction. That is, the processor 101 executes known processing to request the settlement server to make a refund for the target transaction, with a notification of the credit card number included in the card data read from the credit card by the settlement terminal 108. The processor 101 thus executes the information processing based on the transaction processing program PRA to function as a refund unit.

In ACT 222, the processor 101 controls the receipt printer 110 to dispense a receipt for the refund of this time. That is, the processor 101 generates, for example, a receipt image showing the content of the target transaction and the result of refund, and causes the receipt printer 110 to print this receipt image.

In ACT 223, the processor 101 uploads the journal data and the transaction data about the refund of this time to the POS server 200. The processor 101 then ends the past transaction processing.

As described above, if the salesclerk designates automatic determination when the POS terminal device 100 reads card data from a credit card in order to perform the refund processing of a price already settled with the credit card, the POS terminal device 100 is automatically set to use IC reading or magnetic reading if IC reading or magnetic reading is used for the settlement, and to use near-field communication reading if near-field communication reading is used for the settlement. Thus, the time and effort of the salesclerk in the refund processing to cancel the credit cart settlement can be reduced.

Also, when reading card data from a credit card in order to perform the refund processing of a price already settled with the credit card, the POS terminal device 100 can be selectively set in the state of using IC reading or magnetic reading or in the state of using near-field communication reading by a press on the keys KEA, KEB as in the settlement. Thus, a salesclerk who is familiar with the operation of the POS terminal device 100 can execute an operation similar to the operation in the settlement.

The POS terminal device 100 includes the reading method data into the journal data and determines the reading method used for the settlement of a transaction that is a target of refund, based on the reading method data included in the journal data acquired by transaction search. Therefore, the POS terminal device 100 can perform the determination easily and securely.

The embodiments described above can be implemented with various modifications described below.

The processor 101 may omit ACT 211 and ACT 212 in FIG. 10 and may wait for the designation of automatic determination only. The processor 101 may further omit ACT 206 in FIG. 9 and ACT 213 in FIG. 10, and may proceed to ACT 218 if YES in ACT 205 in FIG. 9.

The processor 101 may include the reading method data into the transaction data. In this case, for example, in ACT 203 in FIG. 9, the processor 101 acquires the transaction data about the target transaction from the POS server 200 instead of acquiring the journal data or in addition to acquiring the journal data.

The processor 101 may include the reading method data into data that is different from the journal data and the transaction data.

The POS terminal device 100 can also be implemented as a settlement or payment device that executes a settlement for a transaction registered by another registration device. Even in the case where the POS terminal device 100 is implemented as the settlement device, the registration device may accept the designation of a reading method.

For example, the processor 101, the main memory unit 102, the auxiliary memory unit 103, the salesclerk-side touch panel 104, and the communication unit 113 constitute a mobile device such as a tablet computer to function as the POS terminal device 100.

A part or all of the functions implemented by the processor 101 based on the information processing can also be implemented by hardware executing information processing that is not based on a program, such as a logic circuit. Each of the foregoing functions can also be implemented by a combination of the foregoing hardware such as a logic circuit and software control.

While some embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A point-of-sale (POS) terminal, comprising:
a plurality of card readers each configured to read information from a credit card using a different reading method; and
a processor configured to, upon selection of a reading method from a plurality of reading methods, perform a credit card settlement using one of the plurality of card readers corresponding to the selected reading method, wherein
the processor is further configured to:
search for a past credit card settlement,
acquire data of the past credit card settlement,
identify one of the plurality of reading methods that has been used for the past credit card settlement based on the data,
control one of the plurality of card readers corresponding to the identified reading method to read a credit card, and
upon receipt of information from the credit card via said one of the plurality of card readers, perform refund processing on the past credit card settlement using the information.

2. The POS terminal according to claim 1, wherein the plurality of card readers includes:
a first card reader configured to read information from a credit card using a contactless method, and
a second card reader configured to read information from a credit card using a contact method.

3. The POS terminal according to claim 2, further comprising:
a first display, wherein
the processor is configured to:
control the display to display a screen through which one of the contactless method, the contact method, and an automatic setting can be selected for the refund processing,
upon selection of the contactless method through the screen, control the first card reader to read a credit card,
upon selection of the contact method through the screen, control the second card reader to read a credit card, and
upon selection of the automatic setting through the screen, control one of the card readers corresponding to the identified reading method to read a credit card.

4. The POS terminal according to claim 3, further comprising:
a second display disposed on a first side on which the first and second card readers are disposed, wherein
the first display is disposed on a second side opposite to the first side, and
the processor is configured to control the first and second displays to display an image indicating the selected or identified reading method for reading a credit card.

5. The POS terminal according to claim 3, further comprising:
a first hardware key by which the contactless method is selected;
a second hardware key by which the contact method is selected; and
a touch panel, wherein
the screen shows a software key by which the automatic setting is selected through the touch panel.

6. The POS terminal according to claim 1, wherein the processor is configured to, when performing a credit card settlement using one of the plurality of card readers corresponding to the selected reading method, generate data of the credit card settlement including reading method data indicating the selected reading method.

7. The POS terminal according to claim 6, wherein the processor is configured to identify one of the plurality of reading methods that has been used for the past credit card settlement based on the reading method data.

8. A method performed by a point-of-sale (POS) terminal that includes a plurality of card readers each configured to read information from a credit card using a different reading method, the method comprising:
receiving a selection of a reading method from a plurality of reading methods and performing a credit card settlement using one of the plurality of card readers corresponding to the selected reading method;
searching for a past credit card settlement;
acquiring data of the past credit card settlement;
identifying one of the plurality of reading methods that has been used for the past credit card settlement based on the data;
controlling one of the plurality of card readers corresponding to the determined reading method to read a credit card; and
receiving information from the credit card via said one of the plurality of card readers and performing refund processing on the past credit card settlement using the information.

9. The method according to claim 8, wherein the plurality of reading methods include:
a contactless method of a first card reader in the plurality of card readers, and
a contact method of a second card reader in the plurality of card readers.

10. The method according to claim 9, wherein
control a display of the POS terminal to display a screen through which one of the contact less method, the contact method, and an automatic setting can be selected for the refund processing;
upon selection of the contactless method through the screen, controlling the first card reader to read a credit card;
upon selection of the contact method through the screen, controlling the second card reader to read a credit card; and
upon selection of the automatic setting through the screen, controlling one of the plurality of card readers corresponding to the identified one of the plurality of reading methods to read a credit card.

11. The method according to claim 10, further comprising:
controlling the first display and a second display to display an image indicating the selected or identified reading method for reading a credit card, wherein
the second display is disposed on a first side on which the first and second card readers are disposed, and
the first display is disposed on a second side opposite to the first side.

12. The method according to claim 10, wherein
the contactless method can be selected through a first hardware key of the POS terminal,
the contact method can be selected through a second hardware key of the POS terminal, and
the screen shows a software key by which the automatic setting can be selected through a touch panel of the POS terminal.

13. The method according to claim 8, wherein performing the credit card settlement further includes generating data of the credit card settlement including reading method data indicating the selected one of the plurality of reading methods.

14. The method according to claim 13, wherein the one of the plurality of reading methods that has been used for the past credit card settlement is identified based on the reading method data.

15. A point-of-sale (POS) system, comprising:
a POS server configured to store data of sales transactions performed in a store;
a plurality of card readers installed in the store and each configured to read information from a credit card using a different reading method; and
a processor configured to, upon selection of one of a plurality of reading methods in the store, perform a credit card settlement using one of the plurality of card readers corresponding to the selected reading method, and store data of the credit card settlement in the POS server, wherein
the processor is further configured to:
acquire, from the POS server, data of a past credit card settlement,
identify one of the plurality of reading methods that has been used for the past credit card settlement based on the data,
control one of the plurality of card readers corresponding to the identified reading method to read a credit card, and
upon receipt of information from the credit card via said one of the card readers, perform refund processing on the past credit card settlement using the information.

16. The POS system according to claim 15, wherein the plurality of card readers include:
a first card reader configured to read information from a credit card using a contactless method, and
a second card reader configured to read information from a credit card using a contact method.

17. The POS system according to claim 16, further comprising:
a first display installed in the store, wherein
the processor is configured to:
control the display to display a screen through which one of the contact less method, the contact method, and an automatic setting can be selected for the refund processing,
upon selection of the contactless method through the screen, control the first card reader to read a credit card,
upon selection of the contact method through the screen, control the second card reader to read a credit card, and
upon selection of the automatic setting through the screen, control one of the card readers corresponding to the identified one of the plurality of reading methods to read a credit card.

18. The POS system according to claim 17, further comprising:
a second display disposed on a first side on which the first and second card readers are disposed in the store, wherein
the first display is disposed on a second side opposite to the first side, and
the processor is configured to control the first and second displays to display an image indicating the selected or identified one of the plurality of reading methods for reading a credit card.

19. The POS system according to claim 17, further comprising:
a first hardware key by which the contactless method is selected;
a second hardware key by which the contact method is selected; and
a touch panel, wherein
the screen shows a software key by which the automatic setting is selected through the touch panel.

20. The POS system according to claim 15, wherein the processor is configured to generate the data of the credit card settlement including reading method data indicating the selected one of the plurality of reading methods.
